(19) United States
(12) Patent Application Publication
(10) Pub. No.: US 2025/0268991 A1
(43) Pub. Date: Aug. 28, 2025

(54) FOOD COMPOSITION FOR SUPPRESSING MUSCLE FATIGUE AND/OR SUDDEN MUSCLE PAIN

(71) Applicant: NIPPI, INCORPORATED, Tokyo (JP)

(72) Inventors: Masashi Kusubata, Tokyo (JP); Kumiko Kuwaba, Tokyo (JP); Hiroshi Igarashi, Tokyo (JP); Yuki Taga, Tokyo (JP); Kazunori Mizuno, Tokyo (JP)

(21) Appl. No.: 18/684,230

(22) PCT Filed: Aug. 17, 2022
(86) PCT No.: PCT/JP2022/031077

§ 371 Date: Aug. 1, 2024

(30) Foreign Application Priority Data
Aug. 18, 2021 (JP) 2021-133102

(51) Int. Cl. A61K 38/39; A61K 9/00; A61P 21/00; A61P 29/00

(52) U.S. Cl. CPC A61K 38/39; A61K 9/0056; A61P 21/00; A61P 29/00

(57) ABSTRACT

Provided is a food composition for suppressing muscle fatigue during or immediately after exercise, suppressing sudden muscle pain or increasing muscle strength, and food containing the food composition. The food composition contains a collagen peptide having an average molecular weight of 2,000 or less. The collagen peptide may contain X-Hyp-Gly wherein X is an amino acid residue other than Gly, Hyp and Pro. Such a collagen peptide may be obtained by degrading gelatin with a cysteine protease. The food composition can be used as a food as it is, or may be processed into a food by adding other ingredients thereto. The food composition can suppress muscle fatigue during or immediately after exercise, suppress sudden muscle pain or increase muscle strength.

### TECHNICAL FIELD

The present disclosure relates to a food composition for suppressing muscle fatigue during or immediately after exercise, suppressing sudden muscle pain or increasing muscle strength; a food containing the food composition; and the use of the food composition.

### BACKGROUND ART

Muscle pain that occurs several hours to several days after unaccustomed or strenuous exercise is referred to as delayed-onset muscle pain. In the case of this type of muscle pain, pain is caused by inflammation when muscle tissue is damaged by intense muscles movement and then repaired. In contrast, muscle pain that occurs during or immediately after exercise is referred to as sudden muscle pain. The sudden muscle pain is caused when the muscles become difficult to contract due to lack of energy or the like. The sudden muscle pain results in a feeling of pain, weakness, heaviness, or the like.

When people play strenuous sports, or when people who do not usually exercise much suddenly start moving their bodies, they may feel fatigue or malaise due to muscle fatigue during or immediately after exercise. The muscle fatigue is believed to be caused by the fact that muscle contraction becomes difficult due to an increase in the concentration of a hydrogen ion, the muscle becoming acidic resulting from the production of the hydrogen ion, and the lack of energy supply resulting from the depletion of muscle glycogen as an energy source.

Thus, the delayed-onset muscle pain originates from muscle damage, but sudden muscle pain during or immediately after exercise and muscle fatigue during or immediately after exercise are different from the delayed-onset muscle pain, in that they originate from the lack of energy supply.

In sports and other activities, muscle pain and muscle fatigue reduce exercise performance. PTL 1 describes a composition for preventing and treating muscle fatigue or muscle damage and diseases caused therefrom, containing N-(3,4-dimethoxycinnamoyl) anthranilic acid as an active ingredient. In the Example in Examples of PTL 1, administration of the composition is started after dinner on the day on which exercise load is applied, rather than immediately after exercise, and the effects are compared with a control group to which the composition was not administered. It is stated that as the result, the pain level one day or later after administration of the composition was reduced compared to the control group (“(1) Muscle fatigue test” in PTL 1). In addition, analysis of blood components was performed to examine the variation (%) calculated in terms of the blood concentration of each component immediately after the exercise load of 100%. It is stated that as the result, the blood concentration of each of myoglobin, lactic acid and CPK 3 days or later after the exercise load are all lower in the composition administration group than that in the control group (PTL 1, “(2) Analysis of blood components”).

PTL 2 describes an amino acids-containing composition, having a composition of nine specific amino acids, for promoting recovery from muscle fatigue. The composition of PTL 2 is based on the finding that muscle fibers are damaged in muscles damaged by excessive exercise load, but ingestion of the composition containing the specific amino acids improves the synthesis rate of damaged proteins and promotes recovery from muscle fatigue through recovery from muscle damage. In the Examples, rats are subjected to an eccentric contraction load to induce muscle damage, and subjected to evaluation of the effect of the amino acids-containing composition on preventing and/or improving muscle pain (Test Example 1), evaluation of the effect of the amino acids-containing composition on the synthesis rate of desmin protein and muscle collagen protein (Test Example 2), evaluation of the muscle damage recovery effect (Test Example 3) and evaluation of the recovery promoting effect of muscle strength (Test Example 4). All of the Test Examples in Cited Reference 2 investigates the effects on muscle damage and delayed-onset muscle pain. In particular, in Test Examples 1, 2, and 4, the effects are investigated over 7 hours or later after the exercise load.

PTL 3 describes an anti-fatigue amino acids-containing composition containing arginine, valine and serine as active ingredients. In Example 4, a test substance is administered to a human, and the blood cortisol concentration is measured at rest, before exercise load, after the end of exercise load, after 30 minutes, and after 60 minutes. The blood cortisol concentration is used as an indicator of fatigue and a significantly lower blood cortisol concentration is observed when the anti-fatigue amino acids-containing composition is administered compared to that of the control, and it has been concluded that it has an anti-fatigue effect.

PTL 4 claims, in claim 7, a method for treating a human subject for recovering muscle mass, fatigue and muscle pain or the like, including administering amino acid ingredients including L-methionine of at least 5% by weight of the essential amino acids and at least one other amino acid. PTL 4 describes, in Example 11, that when skiers take the amino acid ingredients at night after skiing all day on the slopes, muscle pain and muscle fatigue are reduced the next morning.

PTL 5 discloses a food composition for preventing and/or improving muscle damage containing a skeletal muscle fiber type controlling agent characterized by containing a collagen peptide as an active ingredient. PTL 5 states, in Examples, that in a test using rats, the transcript level of the α-acnitin 3 (ACTN3) gene is increased in slow-twitch muscle fiber type skeletal muscle of rats that ingest a collagen peptide (without exercise load), 8 hours after administration.

### CITATION LIST

### Patent Literature

PTL 1: International Publication No. WO 2004/017953
PTL 2: International Publication No. WO 2013/021891
PTL 3: International Publication No. WO 2017/142052
PTL 4: Japanese Translation of PCT International Application Publication No. 2020-531006
PTL 5: Japanese Patent Laid-open No. 2021-16335
PTL 6: Japanese Patent No. 6075656

### SUMMARY OF INVENTION

### Technical Problem

Muscle fatigue suppression in PTL 1 and PTL 2, as seen from the descriptions of Examples and the like thereof, suppresses muscle pain based on muscle damage, that is, delayed-onset muscle pain. PTL 3 proposes a composition containing amino acids as a main component and claims a muscle fatigue effect using, as an indicator, the blood cortisol concentration, but cortisol concentration is originally a marker for stress evaluation. In Examples of PTL 4, muscle pain and muscle fatigue are evaluated on the next day after ingestion. PTL 5 investigates the effects of a collagen peptide 8 hours after administration in rats that have not exercised, and aims to control skeletal muscle fiber types.

None of these Patent Literatures has been aimed to suppress muscle fatigue during or immediately after exercise, suppress sudden muscle pain or increase muscle strength.

A collagen peptide composition containing, as a collagen peptide, a peptide represented by X-Hyp-Gly, wherein X is an amino acid residue other than Gly, Hyp and Pro, obtained by adding a ginger rhizome-derived enzyme to a gelatin solution is known (see PTL 6). The theoretical content based on the primary sequence of the X-Hyp-Gly in collagen is about 20 to 25 mol %, but this collagen peptide composition contains the X-Hyp-Gly in a range of 0.01 to 25 mol %. In the Example, a composition of the collagen peptide composition degraded by Clostridium is described for comparison, but the X-Hyp-Gly has not been detected.

Collagen peptides differ in their absorption and metabolism depending on their molecular weight and the type of peptides contained therein, and also differ in their effects on living bodies.

Accordingly, an object of the present disclosure is to provide a food composition, containing a collagen peptide, for suppressing muscle fatigue during or immediately after exercise, suppressing sudden muscle pain or increasing muscle strength.

Another object of the present disclosure is to provide a food containing the food composition.

### Solution to Problem

The present disclosers have found that a collagen peptide suppresses muscle fatigue during or immediately after exercise, suppress sudden muscle pain or increase muscle strength with a statistically significant difference when the collagen peptide is administered to a human and a stratified, randomized, double-blind, cross-over placebo-controlled trial is conducted, and have completed the present disclosure.

The present disclosure provides a food composition, containing a collagen peptide having an average molecular weight of 2,000 or less, for suppressing muscle fatigue during or immediately after exercise, suppressing sudden muscle pain or increasing muscle strength.

The present disclosure also provides a food containing the food composition.

### Advantageous Effects of Invention

According to the present disclosure, a new food composition for suppressing muscle fatigue during or immediately after exercise, suppressing sudden muscle pain or increasing muscle strength, and food containing the food composition are provided.

### BRIEF DESCRIPTION OF DRAWINGS

FIG. 1 is a diagram illustrating the ingestion schedule of the food to be tested (test food and control foods) in a stratified, randomized, double-blind, cross-over placebo-controlled trial performed in the Example.

FIG. 2 is a diagram showing the composition of X-Hyp-Gly, wherein X is an amino acid residue other than Gly, Hyp and Pro, contained in the collagen peptide used in the Example.

FIG. 3 is a diagram showing the composition of Gly-Pro-Y, wherein Y is any amino acid other than Pro, contained in the collagen peptide used in the Example.

FIG. 4 is a diagram showing the composition of free amino acids contained in the collagen peptide used in the Example.

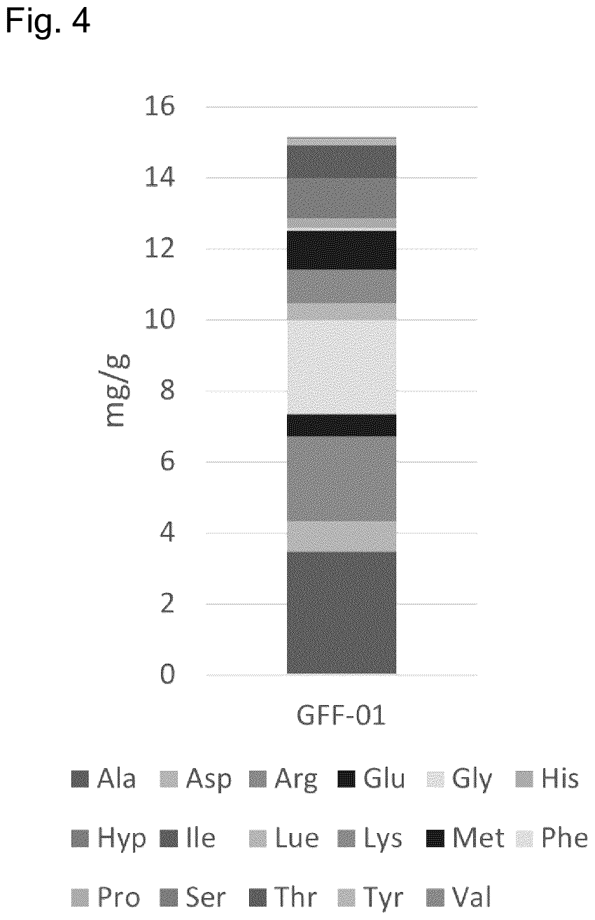

FIG. 5 is a diagram illustrating measurement items of the stratified, randomized, double-blind, cross-over placebo-controlled trial conducted in the Example.

FIG. 6 is a diagram illustrating a visual analog scale (hereinafter referred to as VAS) used as a method for evaluating muscle pain and feeling of fatigue in the Example.

FIG. 7 is a diagram showing statistically significant differences between the test food group and the control food group for the VAS for muscle pain of the Example.

FIG. 8 is a diagram showing statistically significant differences between the test food group and the control food group for the VAS for feeling of fatigue in the Example.

FIG. 9 is a diagram showing statistically significant differences between the test food group and the control food group for muscle strength in the Example.

FIG. 10 is a diagram showing statistically significant differences between the test food group and the control food group for growth hormone (GH) in the Example.

### DESCRIPTION OF EMBODIMENTS

The present disclosure is firstly a food composition, containing a collagen peptide having an average molecular weight of 2,000 or less, for suppressing muscle fatigue during or immediately after exercise, suppressing sudden muscle pain or increasing muscle strength.

Collagen is a type of protein that mainly constitutes the dermis, ligament, tendon, bone, cartilage, and the like of a vertebrate, and is the main component of the extracellular matrix of a multicellular organism. Gelatin is obtained by thermal extraction of collagen and is used for various applications such as foods and cosmetics. For the amino acid residues constituting the peptide chain of collagen protein, collagen has a characteristic amino acid sequence represented by -(Gly-amino acid X-amino acid Y)n-. “Collagen peptide” is a peptide fragment obtained by degrading collagen protein or gelatin protein.

The collagen peptide used in the present disclosure has an average molecular weight of 2,000 or less, preferably 400 to 1,800, more preferably 400 to 1,500, and particularly preferably 400 to 1,200. This is because the collagen peptide having an average molecular weight within this range is excellent in in vivo absorption before and after exercise.

The collagen peptide may be derived from any animal species such as a cow, a pig, a chicken and a fish and may be derived from any part of the animal species. For example, a degraded product of collagen that constitutes a part such as the dermis, ligament, tendon, bone, cartilage or fish scale can be suitably used. The collagen has a characteristic amino acid sequence represented by -(Gly-amino acid X-amino acid Y)n-, and collagen and gelatin which is a degraded product of collagen can be degraded with an acid, an alkali, an enzyme or the like to adjust the average molecular weight to a predetermined value.

The collagen peptide used in the present disclosure is not limited in respect of degradation of collagen or gelatin, but it is preferably one prepared by degradation with a cysteine protease. As the cysteine protease, zingibain, a proline-specific cysteine protease, and a ginger rhizome-derived enzyme that may contain these can be used. The proline-specific cysteine protease cleaves the peptide bond between the amino acid residue adjacent to the C-terminal side of Pro or Hyp (hydroxyproline) and the next adjacent amino acid residue. When the ginger rhizome-derived enzyme is allowed to act on gelatin, collagen peptides X-Hyp-Gly in which the second amino acid residue from the C-terminus is Hyp are produced (see PTL 6). A bacterial collagenase cannot produce X-Hyp-Gly, because it cleaves the peptide bond between Hyp and Gly.

The collagen peptide used in the present disclosure preferably contains a collagen peptide in which the second amino acid from the C-terminus is Pro or Hyp.

The collagen peptide used in the present disclosure preferably contains X-Hyp-Gly wherein X is an amino acid residue other than Gly, Hyp and Pro. The collagen peptide of the present disclosure includes, without limitation, the collagen peptide described in PTL 6. PTL 6 describes, in the Example, that a collagen peptide containing X-Hyp-Gly is administered to healthy subjects and its effect on suppressing a rise in the postprandial blood glucose level has been confirmed, but it includes no description about the effect on suppressing muscle fatigue and sudden muscle pain. The present inventors have surprisingly revealed, as described in the Example below, that the collagen peptide statistically significantly suppresses muscle fatigue during or immediately after exercise, suppresses sudden muscle pain or increases muscle strength.

The collagen peptide used in the present disclosure may contain X-Hyp-Gly wherein X is an amino acid residue other than Gly, Hyp and Pro, and Gly-Pro-Y wherein Y is any amino acid other than Hyp. This is because it has been found that collagen, having a characteristic amino acid sequence represented by -(Gly-amino acid X-amino acid Y)n-, is degraded with a cysteine protease so as to efficiently produce collagen peptides in which the second amino acid from the C-terminus is Pro, that is, X-Hyp-Gly wherein X is an amino acid residue other than Gly, Hyp and Pro, or Gly-Pro-Y wherein Y is any amino acid other than Hyp; and that it is effective in suppressing sudden muscle pain or the like as shown in the Example described later. The content of X-Hyp-Gly, wherein X is an amino acid residue other than Gly, Hyp and Pro, in the collagen peptide is 0.01 to 25% by weight, and preferably 0.1 to 3% by weight. The content of Gly-Pro-Y, wherein Y is any amino acid other than Hyp, in the collagen peptide is 0.1 to 20% by weight, and more preferably 1 to 10% by weight.

As used herein, “immediately after exercise load” in “muscle fatigue during or immediately after exercise” means immediately after finishing exercise, including, but not limited to, preferably within 3 hours, within 2 hours, within 1 hour or within 30 minutes after finishing exercise. As used herein, “muscle fatigue” includes fatigue of the muscle and feeling of malaise caused by exercise load.

As used in the present disclosure, “sudden muscle pain” means muscle pain occurring during or immediately after exercise. Therefore, suppressing sudden muscle pain refers to suppressing muscle pain during or immediately after exercise.

As used herein, “increase muscle strength” means increasing muscle strength, compared to when the composition is not ingested, for example, but not limited to, increasing by at least 1%, increasing by 2%, increasing by 3%, increasing by 5%, increasing by 8% and increasing by of 10%. “Muscle strength” may be measured, for example, one or more days, two or more days, three or more days, or four or more days after applying an exercise load to the subject. The muscle strength is, but not limited to, muscle strength of the lower limbs. The “muscle strength” can be measured using any known method and device.

In the food composition of the present disclosure, a flavoring agent, another peptide and further an excipient such as lactose or starch may be blended in addition to a collagen peptide having an average molecular weight of 2,000 or less, to the extent that the effects of the present disclosure are not impaired.

The amount of the food composition of the present disclosure to be ingested can be appropriately selected based on the type of exercise, age, gender, body weight, dietary state, or the like, but the daily amount to be ingested for an adult is 1 to 30 g, preferably 2 to 20 g, and particularly preferably 3 to 15 g. The food composition may be ingested daily to prevent muscle fatigue and sudden muscle pain, and may be ingested before, during or after exercise.

The subject ingesting the food composition is not limited as long as it is an animal in need of suppressing muscle fatigue during or immediately after exercise, suppressing sudden muscle pain or increasing muscle strength. In one aspect, the subject is a human. In another aspect, the subject may be a non-human mammal. Examples of the non-human mammal include a primate other than a human such as a monkey, chimpanzee or a gorilla; a domestic animal such as a pig, a cow, a horse or a sheep; and a dog, a cat, a rat, a mouse, a guinea pig and a rabbit.

The food composition of the present disclosure may be administered by oral administration or by tube administration. In the food composition of the present disclosure, an odor-masking agent, a taste-masking agent and other ingredients may be blended, depending on the administration method and the like, to the extent that the effects of the present disclosure are not impaired. The food composition may use the collagen peptide as it is in powder form, but the food composition may be formulated into a tablet, a coated tablet, a capsule, a granule, a powder, a solution, a syrup, an emulsion or the like, by blending other ingredients such as an excipient, a binder, a disintegrant, a lubricant, a coloring agent, a flavoring agent, a solubilizing agent, a suspending agent or a coating agent by any technique known in the field of pharmaceutical formulation technology. It may be also ingested in admixture with other food.

The present disclosure is secondly a food containing the food composition. As used in the present disclosure, “food” includes a nutritional supplement such as a supplement; and a tube feeding nutrient such as a nasal or an enteral nutrient.

As used in the present disclosure, the food refers to a food in an edible state that an animal including a human can use directly for eating. The food composition may be therefore used as a food as it is, or as a food by simply changing its form to a powder, a granule, a pellet or the like. The food may be also a liquid or jelly-like drink prepared by adding water and optionally a thickening agent or a flavoring agent to the food composition, or a jelly prepared by hardening the food composition with agar or gelatin.

When the food composition is used as a food, other ingredients added thereto are not limited, provided that they can be used as a food. The ingredients that can be blended in the food composition are water, proteins, carbohydrates, lipids, vitamins, minerals, organic acids, organic bases, fruit juice, flavors or the like.

Examples of the protein include soybean protein, chicken egg protein, meat protein, milk-derived protein, other animal and vegetable proteins and hydrolysates thereof. Examples of the carbohydrate include sugar, fructose, other saccharides, dextrin, cornstarch and dietary fiber. Examples of the lipid include animal fats and oils such as lard, tallow and fish oil, vegetable fats and oils such as palm oil, safflower oil, corn oil and rapeseed oil, and hydrogenated oils thereof. Examples of the vitamin include vitamin A, vitamin B, vitamin C, vitamin D, vimin E, vitamin K, vitamin P, vitamin Q, niacin, nicotinic acid, pantothenic acid, biotin, inositol, choline and folic acid. Examples of the mineral include calcium, potassium, magnesium, sodium, copper, iron, manganese, zinc and selenium. Examples of the organic acid include malic acid, citric acid, lactic acid and tartaric acid. One or more of these ingredients can be added to the food composition and cooked as appropriate to process the food composition into a food.

The food composition may be also added to a known food to prepare a food. Examples of the known food include dairy products such as milk drinks, yogurts and ice creams; drinks such as soft drinks, fruit juice drinks, vegetable drinks, soy milk drinks, sports drinks, tea and coffee; soups such as consomme, potage and powdered soup;
sweets such as Japanese sweets, candies, chocolates, chewing gums, gummies, snacks, jellies and puddings; retort foods such as curry, pot-au-feu, stew, beef bowl and Chinese bowl; noodles such as ramen, pasta, udon and somen; various canned foods such as canned salmon and canned mackerel; cereal foods such as cornflakes and granola; and nutritional supplements such as protein bars and green juices.

A tube feeding nutrient for tube administration may be prepared by adding the food composition to a known tube feeding nutrient, or may be prepared by adjusting some of the ingredients of a known tube feeding nutrient and adding the food composition thereto.

The nutritional supplements can include, for example, the food composition as it is, and liquid and jelly-like products obtained by processing the food composition into powder, granules, pellets or the like and adding water or a thickening agent thereto. The food composition may be also added to any conventionally known supplement.

The food composition and food of the present disclosure can be expected to improve exercise performance by preventing and suppressing muscle fatigue and sudden muscle pain, and thus they can be suitably used by people who do not take regular exercise, sports enthusiast, athletes, pet animals, animals for racing, and the like.

### Use, Method and Others

The present disclosure also relates to a method for suppressing muscle fatigue during or immediately after exercise, suppressing sudden muscle pain or increasing muscle strength, including administering a collagen peptide having an average molecular weight of 2,000 or less to a subject.

The present disclosure also relates to the use of a collagen peptide having an average molecular weight of 2,000 or less in a method for suppressing muscle fatigue during or immediately after exercise, suppressing sudden muscle pain or increasing muscle strength.

The present disclosure also relates to the use of a collagen peptide having an average molecular weight of 2,000 or less in the production of a food composition for suppressing muscle fatigue during or immediately after exercise, suppressing sudden muscle pain or increasing muscle strength.

The present disclosure also relates to a collagen peptide having an average molecular weight of 2,000 or less, used in a method for suppressing muscle fatigue during or immediately after exercise, suppressing sudden muscle pain or increasing muscle strength.

The definitions and scopes of each term related to the above “method” and “use” are as described above with respect to “food composition”.

### EXAMPLE

The present disclosure will be now specifically described with reference to Example, but the Example is not intended to limit the present disclosure in any way.

### Example 1

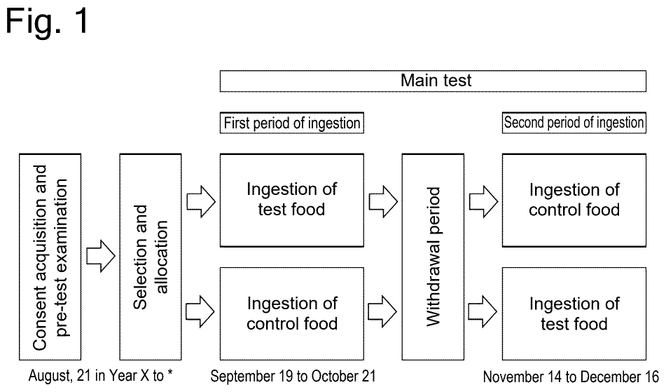

Twenty test participants were selected and stratified randomly into two groups of a test food group and a control food group, with a computer-generated random number table, using, as allocation factor, age, muscle strength, the number of exercise loads which they could perform, and VAS for muscle pain on the day after the exercise load. The test food group is a group that ingests a test food containing a collagen peptide during the first or second period. The control food group is a group that ingests a control food containing no collagen peptide during the first or second period (Table 1). The ingestion schedule of the food to be tested (test food or control food) is shown in FIG. 1. Each food to be tested was ingested twice a day, in the morning and in the evening, for 4 weeks and 5 days, and the effects on post-exercise subjective symptoms and performance at the time point of 4 weeks were confirmed. These effects were evaluated between the food to be tested groups regardless of the timing. When comparing the backgrounds of the test subjects between the food to be tested groups, no significant differences were observed in age, muscle strength, number of exercise loads, and VAS for muscle pain on the next day as allocation factors.

The groups in compilation and analysis are the test food group and the control food group regardless of the timing of ingestion.

TABLE 1
Food to be tested group: name of group that ingests the
same test food type (regardless of timing of ingestion)

| | | Food to be tested | |
|---|---|---|---|
| Name | Name of | for that is ingested | |
| of group | preceding group | First period | Second period |
| Test | Test food | Test food | — |
| food group | preceding group | | |
| | Control food | — | Test food |
| | preceding group | | |
| Control | Test food | — | Control food |
| food group | preceding group | | |
| | Control food | Control food | — |
| | preceding group | | |

One bag containing 5 g of the food to be tested was dissolved in 100 ml of water at normal temperature and was ingested by the test participants twice a day, 30 minutes before breakfast and dinner. The ingestion period was from the day of hospital visit on which the first period of ingestion of the food to be tested was started until the morning ingestion on the fifth day after the first period of exercise load, and from the day of hospital visit on which the second period of ingestion of the food to be tested was started until the morning ingestion on the fifth day after the second period of exercise load, and the food to be tested was ingested daily. For the morning ingestion from the day of exercise load to the fifth day after the exercise load, on the exercise load day, the test participants were asked to visit the hospital without ingesting breakfast on the day of exercise load, and to ingest the prescribed diet 20 to 30 minutes after ingesting the food to be tested and the food to be tested 1 hour before exercise load. On the second and third days after the exercise load, the food to be tested was ingested one hour before recording VAS questionnaires for muscle pain and feeling of fatigue at the time of visiting the hospital. Breakfast was ingested 2 hours or more before ingesting the food to be tested. From the fourth day to the fifth day after the exercise load, the food was ingested at home or the like 1 hour before VAS recording for muscle pain and feeling of fatigue. Breakfast was ingested 2 hours or more before ingesting the food to be tested. Ingestion of the food to be tested ended on the morning of the fifth day.

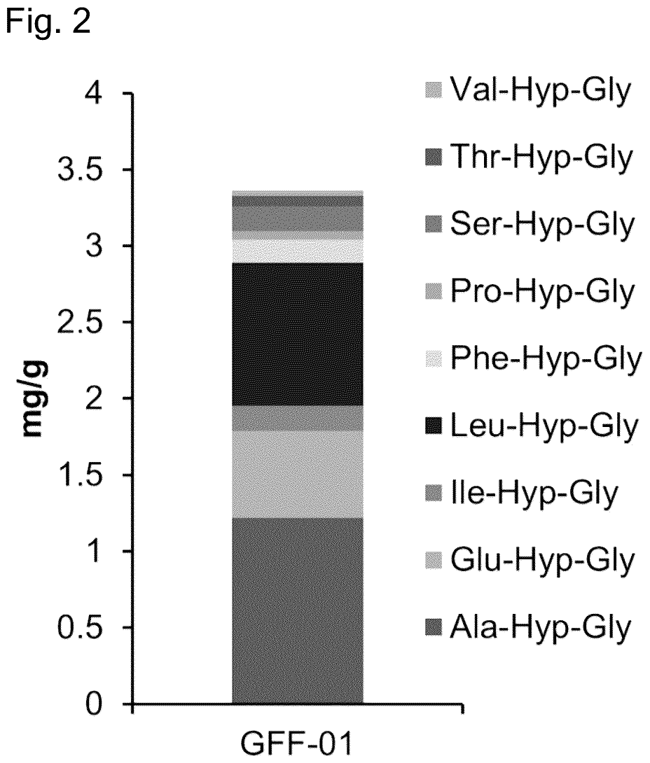

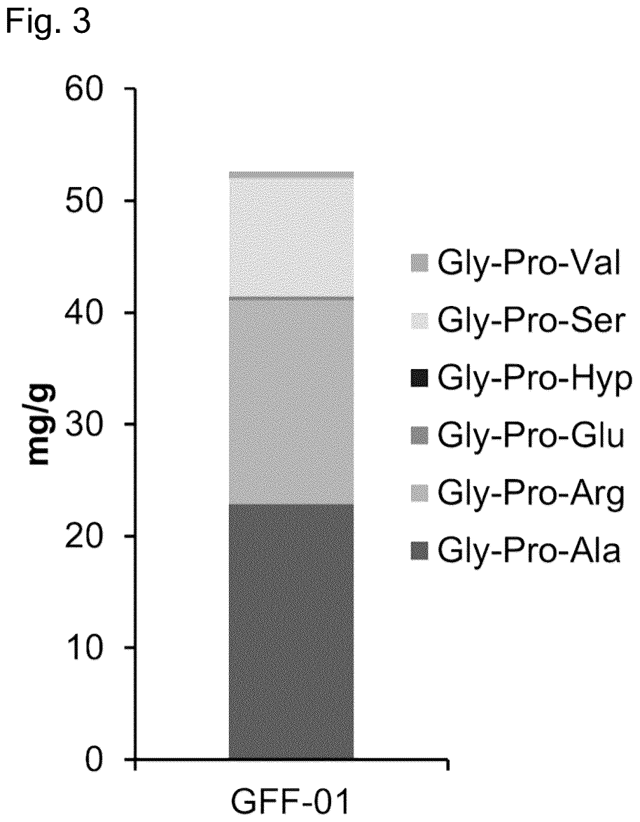

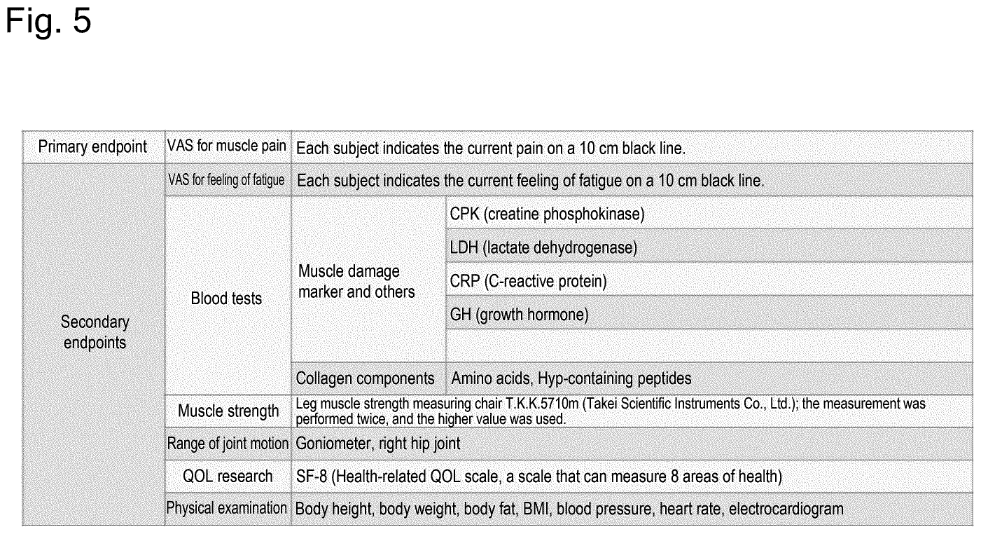

The test food to be used contained 4,985 mg per 5 g bag of a collagen peptide (trade name: GFF-01: a degraded product of fish-derived collagen by a ginger rhizome-derived enzyme having an average molecular weight of 1,000; available from NIPPI, INCORPORATED) as an active ingredient, and had, added thereto, a mango flavor (available from San-Ei Gen F.F.I.) as an odor improving agent and Sannature (available from San-Ei Gen F.F.I.) and sucralose (available from San-Ei Gen F.F.I.) as odor- and taste-masking agents in the total amount of 15 mg/g. The control food to be used was a food that was the same as the test food described above except that dextrin (available from NIPPON STARCH CHEMICAL CO., LTD.) was blended instead of the collagen peptide in in the same amount as the collagen peptide. The types and contents of the collagen tripeptides contained are shown in FIG. 2 (X-Hyp-Gly) and FIG. 3 (Gly-Pro-Y), and the composition of free amino acids is shown in FIG. 5. The collagen peptide contained 3.4 mg/g of X-Hyp-Gly and 53 mg/g of Gly-Pro-Y. The content of the free amino acids was 15.1 mg/g. Table 3 shows the nutritional ingredients of the test food and control food.

TABLE 2
Nutrient ingredients of food to be tested: per 5 g bag

| | |
|---|---|
| Test food | Control food |

| | | | | |
|---|---|---|---|---|
| Calorie | 18.9 | kcal | 19.0 | kcal |
| Moisture content | 0.2 | g | 0.2 | g |
| Protein | 4.6 | g | 0.0 | g |
| Carbohydrate | 0.1 | g | 4.8 | g |

Exercise for load was performed by squatting. Each test participant performed squats while stood with the feet shoulder-width apart and crossing the arms crossed over the chest. One set of squats (2 minutes 40 seconds) contained 40 squats of once every 4 seconds. During the first and second period of exercise load, each test participant performed 5 set of this squat set with 20 seconds of rest in between. All test participants had been able to perform 5 sets at the time of the screening test.

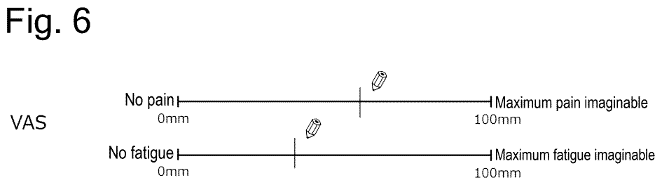

As shown in FIG. 5, for the endpoint to be evaluated, the primary endpoint was muscle pain, and the secondary endpoints were feeling of fatigue, blood tests (blood CPK, blood LDH, blood GH as muscle damage markers, and Hyp-containing peptides and a free Hyp as collagen components), muscle strength, joint range of motion, QLO test and physical test. The incidence rates of adverse events and side effects were also evaluated as safety endpoints. The muscle pain and feeling of fatigue were evaluated using a visual analog scale (VAS). FIG. 6 shows the concept of VAS. For example, in the case of pain, using a straight line with “no pain” at one end and “the strongest pain” at the other end, the subject marks a point on the straight line according to the degree of pain he/she feels.

For the primary and secondary endpoints, comparison between the food to be tested groups was evaluated by a paired t-test using the measured values and the amount of change from before exercise load. In addition, the comparison over time among the measured values before exercise load, immediately after exercise load, 120 minutes after exercise load, on the second day after exercise load (on awakening, daytime), on the third day after exercise load (daytime), on the fourth day after exercise load (daytime) and on the fifth days after exercise load (daytime) was evaluated by Dunnett's test. The incidence rates of the adverse events and the side effects were calculated by:

$$incidence rate ( \% ) = number of incidence cases \div number of test subjects \times 100.$$

### (1) Muscle Pain

### Measurement of Muscle Pain was as Follows.

After ingesting the food to be tested for 4 weeks, on the day of exercise load, each subject first performed three squats, and recorded the muscle pain before exercise load. The three squats before measuring the muscle pain were for measuring the muscle pain and were not “exercise load” (the same applies hereinafter). Each subject recorded the muscle pain immediately after exercise load (40 squats per set×5 sets), and performed three squats 120 minutes after exercise load and then recorded the muscle pain. On the second day after the exercise load, each subject performed three quats on awakening and then recorded the muscle pain, and performed three squats in the daytime and then recorded the muscle pain. On the third day after the exercise load, each subject performed three squats in the daytime and then recorded the muscle pain. On the fourth and fifth days after the exercise load, each subject performed three squats in the daytime and then recorded the muscle pain.

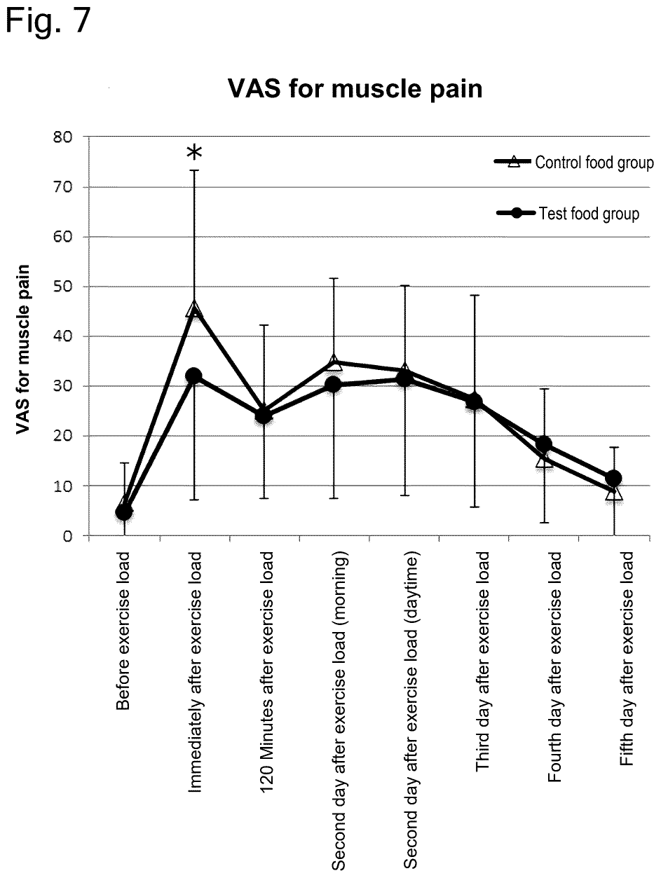

FIG. 7 shows the measured values of VAS for muscle pain for the control food group and test food group. In the intergroup comparison between the control food group and the test food group for VAS for muscle pain, immediately after exercise load, the test food group had a value of 32.03±24.95 mm, compared to 45.75±27.58 mm for the control food group and showed a statistically significant low value (p<0.05). The statistically significant difference is indicated by *.

In evaluation for the changes over time in muscle pain in the control food group and the test food group, in both groups, statistically significant increases were observed immediately after the exercise load, on the second day after the exercise load, on the third day after the exercise load and on the fourth day after the exercise load, compared to before the exercise load (statistically significant differences in changes over time are not shown in FIG. 7).

### (2) Feeling of Fatigue

### Measurement of Feeling of Fatigue was as Follows.

After ingesting the food to be tested for 4 weeks, on the day of the exercise load, each subject first performed three squats, and recorded the feeling of fatigue before exercise load. The three squats before measuring the feeling of fatigue were for measuring the feeling of fatigue and were not “exercise load” (the same applies hereinafter). Each subject recorded the feeling of fatigue immediately after exercise load (40 squats per set×5 sets), and performed three squats 120 minutes after exercise load and then recorded the feeling of fatigue. On the second day after the exercise load, each subject performed three squats on awakening and then recorded the feeling of fatigue, and performed three squats in the daytime and then recorded the feeling of fatigue. On the third day after the exercise load, each subject performed three squats in the daytime and then recorded the feeling of fatigue. On the fourth and fifth days after the exercise load, each subject performed three squats in the daytime and then recorded the feeling of fatigue.

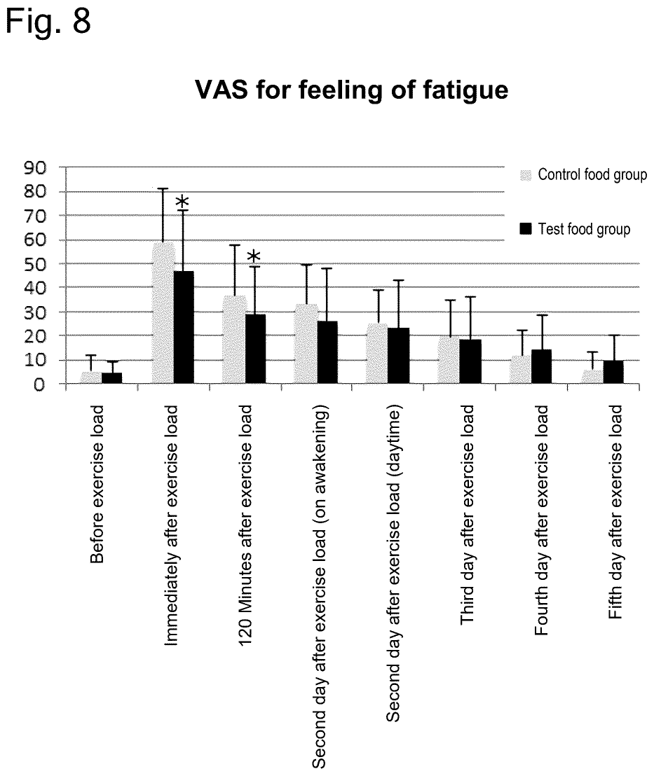

FIG. 8 shows the measured values of VAS for feeling of fatigue for the control food group and test food group. In the intergroup comparison between the control food group and the test food group for VAS for feeling of fatigue, immediately after exercise load, the test food group had a value of 47.25±25.05 mm, compared to 58.97±22.2 mm for the control food group, and showed a statistically significant low value (p<0.05). 120 minutes after the exercise load, the test food group had a value of 28.64±20.17 mm, compared to 37.00±20.74 mm for the control food group and showed a statistically significant low value (p<0.05). The statistically significant difference is indicated by *.

In evaluation for the changes over time in feeling of fatigue in the control food group and the test food group, in both groups, statistically significant increases were observed immediately after the exercise load, on the second day after the pretest and on the third day after the pretest, compared to before the exercise load. In the test food group, a statistically significant increase was observed on the fourth day after the pretest compared to before the exercise load (statistically significant differences in changes over time are not shown in FIG. 8).

### (3) Muscle Strength

Muscle strength was measured with a leg muscle strength measuring chair T.K.K.5710m (Takei Scientific Instruments Co., Ltd.) with an attachment for tension K.K.5402 (Takei Scientific Instruments Co., Ltd.) attached thereto. Each subject was seated on the leg muscle strength measurement chair, with the arms crossed in front of the chest without touching the measurement chair, and the leg muscle strength of both legs was measured. The measurement was performed twice, and the higher value was used.

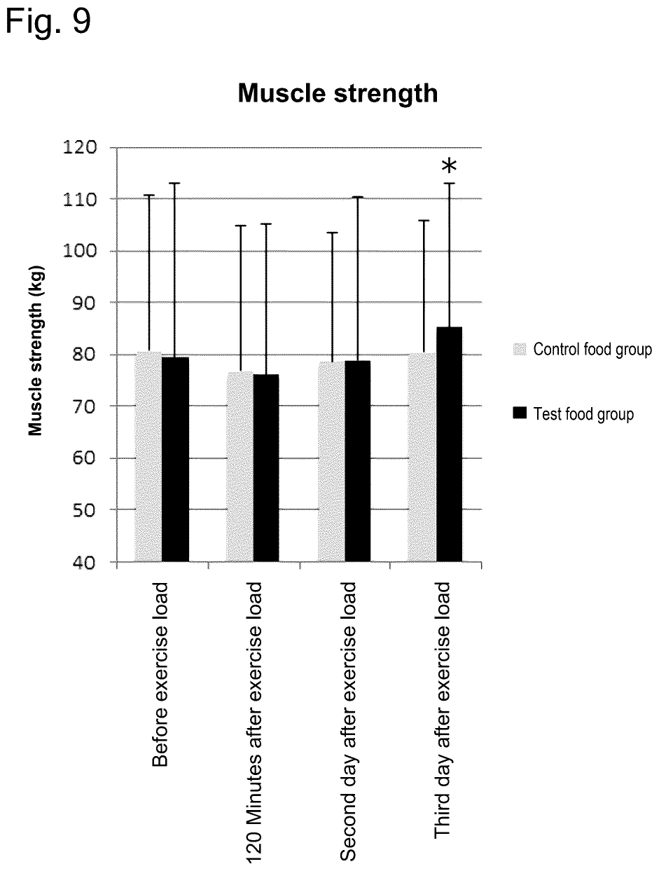

Table 3 and FIG. 9 show the measured values and the amounts of change for the muscle strength in the control food group and test food group.

TABLE 3

| | Muscle strength (kg) | | | | | |
|---|---|---|---|---|---|---|
| | Measured value | | | Amount of change | | |
| | Control food | Test food | | Control food | Test food | |
| | group | group | | group | group | |
| Before exercise load | 80.81 ± 29.71 | 79.31 ± 33.60 | | 0.00 ± 0.00 | 0.00 ± 0.00 | |
| 120 Minutes after | 76.94 ± 27.72 | 76.00 ± 29.07 | | −3.86 ± 10.47 | −3.31 ± 8.96 | |
| exercise load | | | | | | |
| Second day after | 78.75 ± 24.73 | 78.83 ± 31.45 | | −2.06 ± 10.36 | −0.47 ± 5.41 | |
| exercise load | | | | | | |
| Third day after | 80.47 ± 25.34 | 85.22 ± 27.80 | **, # | −0.33 ± 10.07 | 5.92 ± 8.90 | # |
| exercise load | | | | | | |

n = 36 (Control food group: n = 18, Test food group: n = 18)
Average value ± standard deviation
Comparison over time: * p < 0.05, ** p < 0.01 (Dunnett's test)
Intergroup comparison: # p < 0.05, ## p < 0.01 (Paired t-test)

For comparison between the test food group and the control food group, the actual measured values were tested, and a statistically significant difference was observed on the third day after the exercise load. The test food group had a value of 85.22±27.80 kg, compared to 80.47±25.34 kg for the control group and showed a statistically significant higher value (p<0.05). In comparison between the food to be tested groups using the amount of change from at the time of starting ingestion of the food to be tested or before the exercise load, a statistically significant difference was observed for the third day after the exercise load. The test food group had a value of 5.92±8.90 kg, compared to −0.33±10.07 kg for the control group and showed a statistically significant higher value (p<0.05).

In comparison over time of the actual measured values with those before the exercise load, statistically significant variations were observed only in the test food group. The value on the third day after the exercise load was 85.22±27.80 kg, compared to the value before exercise load of 79.31±33.60 kg, and showed a statistically significant increase (p<0.01).

Immediately after the exercise load and on the second day after the exercise load, the average value of the muscle strength decreased due to the influence of delayed-onset muscle pain and the like, but on the third day after the exercise load, only the test food group showed the muscle strength equal to or higher than that before the exercise load.

### (4) Joint Range of Motion

In comparison between the food to be tested groups for the values regarding the joint range of motion, no statistically significant differences were observed at any time point. In comparison of the values regarding the joint range of motion with those before exercise load, no statistically significant differences were detected at all time points in the control food group and the test food group.

### (5) Blood Test for Muscle Damage

Variations before and after exercise load were followed up, using, as markers of muscle damage, CPK, LDH and growth hormone (GH) that are known to be involved in energy metabolism of muscle cells and to temporarily increase in the blood concentration with the damage of muscle cells due to exercise load using muscles.

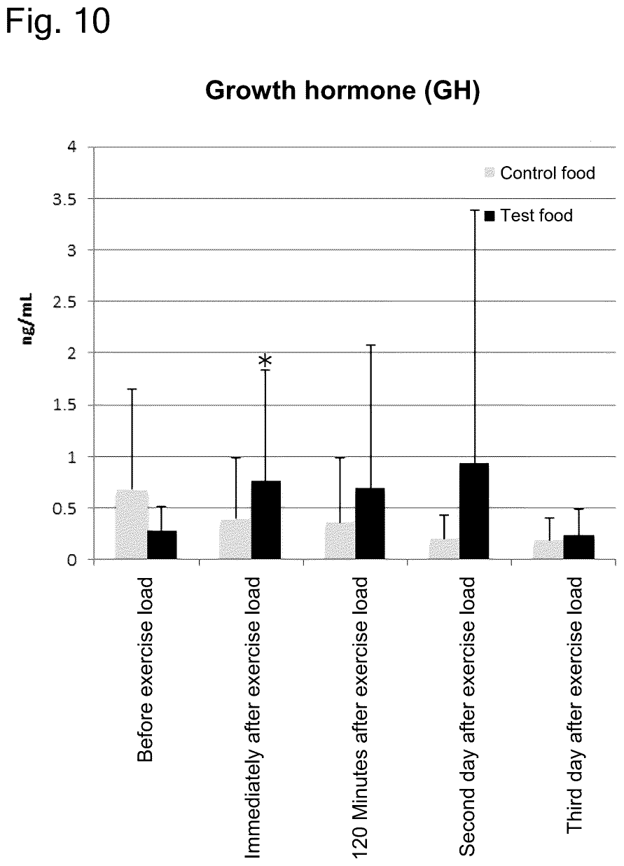

In comparison between the food to be tested groups, immediately after the exercise load, for the growth hormone (GH), the test groups showed a statistically significantly high value of 0.759±1.083 ng/mL compared to 0.401±0.582 ng/ml in the control food group (p<0.05). The results are shown in FIG. 10. It was suggested that ingestion of the test food improved exercise performance after the exercise load. It is believed that ingestion of the test food enhanced the promotion of GH secretion due to the exercise load and the growth effect of GH on the muscle tissue led to an increase in muscle strength.

No statistically significant differences were detected for CPK and LDH at any time of measurement in the comparison between the food to be tested groups.

### (6) Hyp-Containing Peptides and Free Hyp in Blood

In intergroup comparison of blood collagen using the actual measured values, the test group showed a statistically significantly high value of a free Hyp, which is an amino acid specific to collagen, compared to the control food group, before the exercise load, immediately after the exercise load, 120 minutes after the exercise load, on the second day after the exercise load and on the third day after the exercise load (p<0.01).

In comparison between the food to be tested groups, no difference in blood concentration was observed in the Hyp-containing oligopeptides before the exercise load between the food to be tested groups. Among the oligopeptides containing Hyp, Phe-Hyp, Ser-Hyp, Lue-Hyp, Hyp-Gly, Pro-Hyp, Ala-Hyp, Pro-Hyp-Gly, Ser-Hyp-Gly, Glu-Hyp-Gly, Gly-Pro-Hyp and Ala-Hyp-Gly showed statistically significantly high values in the test food group compared to the control food group, immediately after the exercise load, on the second day after the exercise load and on the third day after the exercise load (p<0.01). Among these, Hyp-Gly, Pro-Hyp, Ala-Hyp, Gly-Pro-Hyp and Ala-Hyp-Gly showed statistically significantly high values in the test food group compared to the control food group, also 120 minutes after the exercise load (p<0.01). For Leu-Hyp-Gly and Phe-Hyp-Gly, no difference in blood concentration was observed between the control food group and the test food group at any point of time. It was presumed to be because many test subjects showed values below the detection limit.

### (7) QOL Research

In comparison between the food to be tested groups, no statistically significant differences were observed for all endpoints.

### (8) Physical Examination

In comparison between the food to be tested groups, no statistically significant differences were observed for all endpoints.

### (9) Comprehensive Assessment

As described above, regarding muscle pain, it was found that the test group was significantly low in VAS for muscle pain immediately after exercise load compared to the control group, resulting in suppressing sudden muscle pain. Regarding VAS for feeling of fatigue, the test food group was significantly low in VAS for feeling of fatigue immediately after the exercise load and 120 minutes after the exercise load, indicating a reduction in muscle fatigue. The test food group showed a significantly high muscle strength compared to the control group on the third day after the exercise load. The mechanism of action by which the test food suppresses sudden muscle pain, alleviates muscle fatigue and increases muscle strength is unknown. However, as shown in FIG. 2 and FIG. 3, the test food contained high concentrations of Hyp-containing tripeptides represented by X-Hyp-Gly, wherein X is an amino acid residue other than Gly, Hyp and Pro, and Hyp-Gly-containing tripeptides represented by Gly-Pro-Y, wherein Y is any amino acid. This was believed to be related to the fact that muscle strength was improved by ingesting these for four weeks, and that the test food group was statistically significantly high in muscle strength compared to the control food group immediately after the exercise load (p<0.01), and it was therefore presumed that containing these at high concentrations helped to suppress sudden muscle pain and muscle fatigue.

In the above study, no severe or critical cases was observed during the observation period for adverse events or side effects, and it was therefore believed that there were no safety problems with continued ingestion of the test food.

### INDUSTRIAL APPLICABILITY

The food composition of the present disclosure is useful because it can suppress muscle fatigue during or immediately after exercise, suppress sudden muscle pain or increase muscle strength.

1. A food composition, comprising a collagen peptide having an average molecular weight of 2,000 or less, for suppressing muscle fatigue during or immediately after exercise, suppressing sudden muscle pain or increasing muscle strength.

2. The food composition according to claim 1, wherein the collagen peptide comprises a collagen peptide in which the second amino acid from the C-terminus is Pro or Hyp.

3. The food composition according to claim 1 or 2, wherein the collagen peptide comprises X-Hyp-Gly wherein X is an amino acid residue other than Gly, Hyp and Pro.

4. A food comprising the food composition according to any of claims 1 to 3.
